(19) United States
(12) Patent Application Publication
(10) Pub. No.: US 2008/0035187 A1
(43) Pub. Date: Feb. 14, 2008

(54) Fuel supply component cleaning system

(76) Inventors: Cory Andrew Brown, Peoria, IL (US); Kevin James Karkkainen, Washington, IL (US); John Gierszewski, Creve Coeur, IL (US); Curtis Graham, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/641,777

(22) Filed: Dec. 20, 2006

Related U.S. Application Data
(63) Continuation-in-part of application No. 11/503,306, filed on Aug. 14, 2006.

(51) Int. Cl. B08B 3/00

(52) U.S. Cl. 134/169 A

(57) ABSTRACT

A method is provided for operating a regeneration assembly to regenerate a filter assembly during a regeneration cycle, and for supplying fuel through a fuel flow path to at least one fuel injector unit associated with the regeneration assembly during the regeneration cycle. The method includes dispensing a cleaning substance into the fuel flow path during a cleaning cycle. The method further includes directing the cleaning substance through the at least one fuel injector unit during the cleaning cycle.

This application is a continuation-in-part of U.S. patent application Ser. No. 11/503,306, filed Aug. 14, 2006, the entire contents of which are hereby incorporated by reference.

### TECHNICAL FIELD

The present disclosure is directed to a fuel supply component cleaning system and, more particularly, to a system and method for cleaning a fuel injector unit for a regeneration assembly.

### BACKGROUND

Engines, including diesel engines, gasoline engines, natural gas engines, and other engines known in the art, may exhaust a complex mixture of emissions. The emissions may include both gaseous and solid material, such as, for example, particulate matter. Particulate matter may include ash and unburned carbon particles generally referred to as soot.

Environmental concerns have resulted in the development of systems to treat engine exhaust. Some of these systems may employ exhaust treatment devices, such as particulate filters, to remove particulate matter from the exhaust flow, or other aftertreatment assemblies designed to control emissions. A particulate filter may include filter material designed to capture particulate matter. After an extended period of use, however, the filter material may become partially saturated with particulate matter, such as soot. This partial saturation may hinder the ability of the particulate filter to remove particulates from the exhaust flow.

The collected particulate matter may be removed from the filter material through a process called regeneration. A particulate filter may be regenerated by increasing the temperature of the filter material and the particulate matter in the filter material above the combustion temperature of the particulate matter. For regeneration to occur, oxygen must be available to facilitate oxidation of the soot. The increase in temperature results in oxidation of the collected particulate matter. The chemical reaction is C+O₂=>CO₂.

The increase in temperature to support oxidation of soot may be effectuated by a regeneration assembly including a combustion chamber. The combustion chamber may require a fuel injector unit for fuel that is to be ignited within the combustion chamber. In addition, a fuel supply circuit, including a flow passage or flow passages, may be provided for delivering the fuel from a source to the fuel injector unit. During regeneration, fuel may flow through the fuel supply circuit and the fuel injector unit to support combustion within the regeneration assembly.

After a regeneration event or cycle, the supply of fuel to the regeneration assembly may be shut off. However, fuel may remain within the fuel supply circuit and the fuel injector unit. The fuel injector unit and/or fuel supply circuit may be subjected to a build-up of substances that may be contained within or derived from fuel remaining within the fuel injector unit and/or fuel supply circuit. For example, when fuel remains within a fuel injector unit and/or fuel supply circuit for a time, the environment is conducive to a build-up of carbon deposits. Such a build-up of substances may inhibit proper operation of the fuel injector unit and/or fuel supply circuit, and may adversely affect performance of the regeneration assembly.

Nozzle purging of fuel injector units may be effective in removing fuel from a fuel injector unit. However, residual fuel may remain in the fuel supply circuit after regeneration, and may leak toward the fuel injector unit. Moreover, valves in the fuel supply circuit may be subject to seepage or leakage, resulting in fuel leaking to the fuel injector unit after nozzle purging. As a result, the fuel injector unit may be exposed to contact with non-flowing fuel for a time sufficient to cause a build-up of deposits which may adversely affect fuel delivery to the regeneration assembly. Such a build-up may require fuel injector unit removal for cleaning, or replacement, and resulting downtime.

One system for purging a fuel injector nozzle is disclosed in U.S. Pat. No. 4,987,738, issued to Lopez-Crevillen et al. on Jan. 29, 1991 (“the '738 patent”). The '738 patent discloses a filter for exhaust gases, and a burner that may regenerate the filter. In the '738 patent, a fuel pump directs fuel to a fuel injector nozzle which injects fuel into the burner during regeneration. Following a regeneration event, an Electronic Control Module (ECM) controls a solenoid valve to shut off fuel to the fuel pump, and direct purge air from an air pump, through the fuel pump, and through the fuel injector nozzle. Purge air continues to flow through the fuel pump and the fuel injector nozzle until a subsequent regeneration event to prevent soot build-up on the nozzle.

While the system of the '738 patent discloses purging a fuel pump and fuel injector nozzle, no provision is made for dispensing a cleaning substance to clean the fuel injection nozzle. Rather, the '738 patent discloses that purge air alone is relied on to maintain the nozzle while a regeneration event is not occurring.

The purging system of the '738 patent may not adequately prevent the build-up of deposits in nozzle components. Air alone may purge some of the liquid fuel from nozzle components, but may not remove all fuel from the nozzle components, and may not clean nozzle components and fuel lines by removing the build-up of deposits.

The disclosed cleaning system and method are directed toward improvements in the foregoing technology.

### SUMMARY OF THE INVENTION

In one exemplary embodiment of the present disclosure, a method comprises operating a regeneration assembly to regenerate a filter assembly during a regeneration cycle, and supplying fuel through a fuel flow path to at least one fuel injector unit associated with the regeneration assembly during the regeneration cycle. The method includes dispensing a cleaning substance into the fuel flow path during a cleaning cycle. The method further includes directing the cleaning substance through the at least one fuel injector unit during the cleaning cycle.

In another exemplary embodiment of the present disclosure, a system comprises a regeneration assembly configured to regenerate a filter assembly during a regeneration cycle, and a combustion chamber associated with the regeneration assembly. The system includes a fuel injector unit for injecting fuel into the combustion chamber during the regeneration cycle. The system also includes a fuel flow path configured to direct fuel to the fuel injector unit. The system further includes an assembly configured for dispensing a cleaning substance into the fuel flow path for cleaning the fuel injector unit during a cleaning cycle.

In another exemplary embodiment of the present disclosure, a machine comprises an engine system including an exhaust flow path. The machine includes a filter assembly in the exhaust flow path. The machine also includes a regeneration assembly proximate the exhaust flow path upstream of the filter assembly, the regeneration assembly including a combustion chamber and configured to regenerate the filter assembly during a regeneration cycle. The machine also includes at least one fuel supply circuit and at least one fuel injector unit associated with the combustion chamber. The machine further includes an assembly configured to dispense a cleaning substance into the at least one fuel supply circuit and to the at least one fuel injector unit.

### BRIEF DESCRIPTION OF THE DRAWINGS

FIG. 1 is a diagrammatic and schematic illustration of a machine including a system according to an exemplary embodiment of the present disclosure, and illustrating a valve in one possible setting for directing fluid flow;

FIG. 2 is a diagrammatic and schematic illustration of a machine including a system according to an exemplary embodiment of the present disclosure, and illustrating a valve in another possible setting for directing fluid flow;

FIG. 3 is a diagrammatic illustration of a cleaning system according to an exemplary embodiment of the present disclosure;

FIG. 4 is a diagrammatic illustration of a cleaning system according to another exemplary embodiment of the present disclosure;

FIG. 5 is a chart showing a purging control strategy;

FIG. 6 is a diagrammatic illustration of an exemplary embodiment of a system for introducing a cleaning substance; and

FIG. 7 is a diagrammatic illustration of another exemplary embodiment of a system for introducing a cleaning substance.

### DETAILED DESCRIPTION

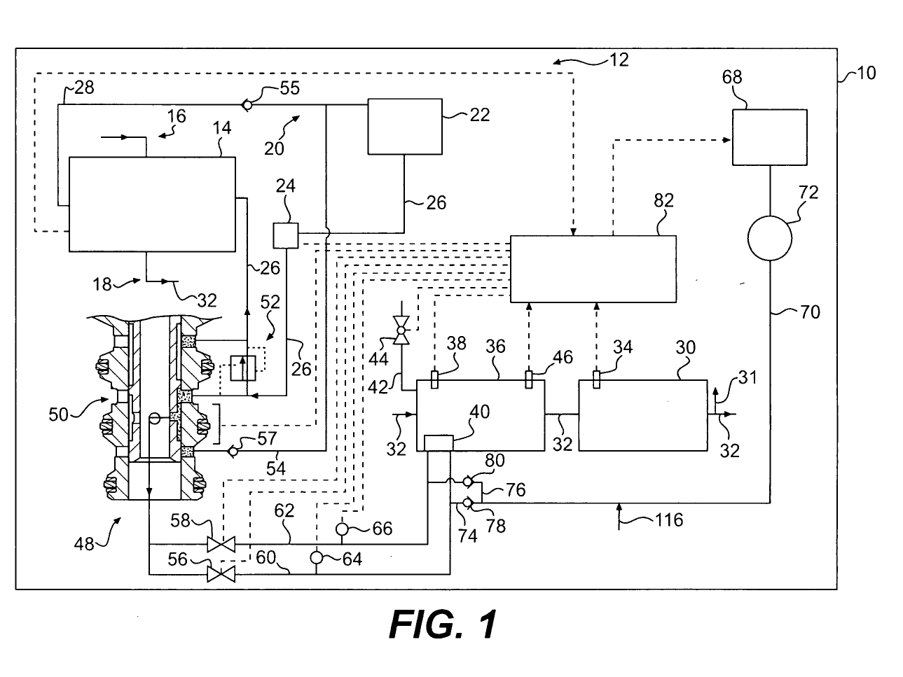

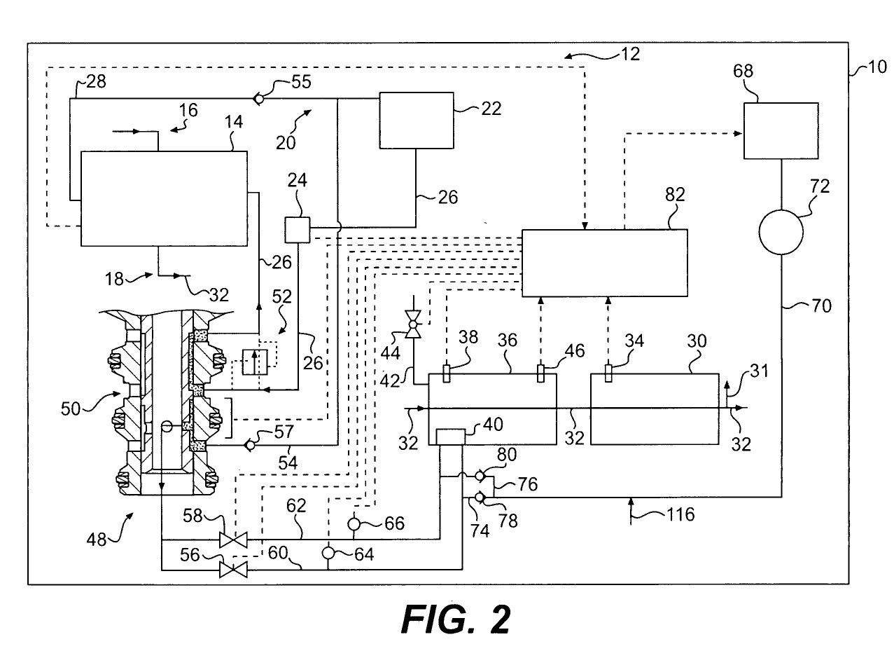

A machine 10, in which exemplary disclosed embodiments may be implemented, is diagrammatically represented in FIG. 1 and in FIG. 2. Machine 10 may be any of various machines, including an on-highway truck, an off-highway haulage unit, an excavating machine, a material handling machine, a stationary power generating machine, any of various heavy equipment machines, or any other machine which may benefit from implementation of embodiments according to the disclosure.

An engine system 12 may be associated with machine 10. Engine system 12 may include an engine 14 and various subsystems generally associated with an engine. Engine 14 may be any one of various types of engines, such as, a gasoline fueled engine, a diesel fueled engine, or a gas fueled engine. Engine 14 may require, among other things, an air intake system 16 and an exhaust system 18, both diagrammatically illustrated in FIG. 1. Air intake system 16 may include various unillustrated intake system components generally associated with engine air intake systems. For example, air intake system 16 may include an opening for intake air, an air filter for filtering the intake air, an intake manifold, and an intake air flow passage for directing intake air from an intake opening to the intake manifold.

Exhaust system 18 also may include various unillustrated exhaust system components generally associated with an exhaust system. For example, exhaust system 18 may include an exhaust manifold, and one or more energy extracting devices, such as turbines, which may in turn drive one or more air pressurizing devices, such as compressors suitably situated in the air intake system for compressing intake air. Additionally, various components particularly designed to control exhaust emissions may be associated with the exhaust system.

In order to better illustrate the various components of a disclosed embodiment, exhaust system 18 is illustrated as discontinuous. It will be understood, however, that exhaust system 18 extends continuously from a location at which it is connected to engine 14, for example at an exhaust manifold, to a position where exhaust is ultimately emitted to the environment. Between the location at which exhaust system 18 is connected to engine 14 and the location at which exhaust is emitted to the environment, engine exhaust may undergo various treatment processes, may drive energy extracting devices, and/or may be diverted for mixing with engine combustion air.

A fuel supply system 20 may supply a suitable fuel to engine 14. Fuel supply system 20 may include a fuel source 22, such as a tank, one or more suitable fuel pumps, such as fuel pump 24, and various fuel flow passages, valves, and elements generally associated with an engine fuel system. Fuel supply system 20 may include a fuel manifold, or fuel rail, and one or more engine fuel injector units, all not shown. Fuel may be directed to engine 14 via suitable fuel flow passages designated 26. Fuel may be directed from engine 14 back to tank 22 via a suitable return line 28.

An aftertreatment device, such as filter assembly 30, may be provided in the exhaust flow path 32. Filter assembly 30 may include, for example, a diesel particulate filter which may remove soot and other particulates from exhaust gases. As filter assembly 30 accumulates removed soot and other particulates, filter assembly 30 may tend to become less efficient in its intended purpose, and/or may tend to restrict the flow of exhaust gases. One or more suitable diagnostic devices, such as diagnostic device 34, for example, may monitor one or more parameters (e.g., temperature, pressure, etc.) associated with the accumulation of soot and particulates in filter assembly 30. Diagnostic device 34 may communicate with a controller 82 via a suitable communication line illustrated by a dotted line in FIGS. 1 and 2. Downstream of filter assembly 30, a portion of filtered exhaust gas may be diverted to a clean gas injection system, diagrammatically indicated at 31, for mixing with combustion air for engine 14, for example.

A regeneration assembly 36 may be located upstream of filter assembly 30, and generally proximate thereto, in or proximate to the exhaust flow path 32. Regeneration assembly 36 may include a suitable combustion chamber, not separately shown, into which fuel and air may be introduced and ignited by a suitable ignition device, such as igniter 38. Alternatively, fuel may be supplied to a catalyst that permits autoignition. Heat generated by combustion within the regeneration assembly 36 may raise exhaust gases to a temperature sufficient to consume soot accumulated in proximately situated filter assembly 30.

Referring to FIGS. 1 and 2, the general flow of exhaust through exhaust flow path 32, and the arrangement of elements associated with regeneration assembly 36, are diagrammatically illustrated. Fuel for combustion within regeneration assembly 36 may be introduced via at least one fuel injector unit designated 40 and diagrammatically illustrated. It will be understood that fuel injector unit 40 may be any suitable injector or nozzle designed for and capable of injecting fuel into the combustion chamber of regeneration assembly 36. It will also be understood that there may be plural injector units, and that injector unit 40 may include plural injectors or nozzles. For example, fuel injector unit 40 may include an injector assembly designed to inject a pilot of fuel and a main injection of fuel.

A source of combustion air may be delivered to regeneration assembly 36 via a combustion air flow passage 42. Delivery of combustion air via flow passage 42 may be suitably controlled with a valve unit 44. Combustion air may be derived directly from ambient, may be derived from air intake system 16 of engine 14, may be derived from a suitable compressor, and may include a mixture of air and exhaust gases derived from exhaust system 18, for example via clean gas injection system 31.

One or more suitable diagnostic devices, such as diagnostic device 46, may be associated with regeneration assembly 36 to monitor one or more parameter associated with the operation of regeneration assembly 36. For example, diagnostic device 46 may monitor temperature, pressure, or build-up of particulates. Diagnostic device 46 may communicate with controller 82 via a suitable communication line.

Fuel injector unit 40 may be a component of a fuel supply circuit, generally designated 48. Fuel supply circuit 48 may be an independent fuel delivery system, or, as illustrated in the exemplary embodiment of FIGS. 1 and 2, fuel supply circuit 48 may be integrated with the engine fuel supply system 20. In the exemplary embodiment of FIGS. 1 and 2, fuel for regeneration assembly 36 is supplied from fuel source 22 by one or more fuel pumps, such as fuel pump 24, via fuel flow passage 26. Fuel flow passage 26 may deliver fuel through an enable valve 50, through suitable fuel passages in fuel supply circuit 48, and to fuel injector unit 40.

Within fuel supply circuit 48, enable valve 50 may be arranged to facilitate delivery of fuel to regeneration assembly 36. In the exemplary embodiment illustrated in FIG. 1, enable valve 50 may also facilitate delivery of fuel to engine 14. Enable valve 50 may be any type of valve capable of facilitating fuel delivery to regeneration assembly 36, or to both regeneration assembly 36 and other machine elements, such as engine 14. For example, enable valve 50 may be a 4-way valve, partially illustrated in FIG. 1.

Referring to FIG. 1, enable valve 50 is illustrated in a position permitting fuel to flow through fuel supply circuit 48 toward regeneration assembly 36. Thus, in the enable valve 50 position illustrated in FIG. 1, fuel may flow from fuel source 22 and be delivered by fuel pump 24 via fuel flow passage 26 through enable valve 50 and fuel supply circuit 48 to regeneration assembly 36. As also illustrated in FIG. 1, fuel may flow from fuel source 22 and be delivered by fuel pump 24 via fuel flow passage 26 and relief valve assembly 52 to engine 14.

Referring now to FIG. 2, which is essentially identical to FIG. 1 in all respects except that FIG. 2 illustrates enable valve in a position inhibiting the flow of fuel to regeneration assembly 36, and directing the flow of fuel to engine 14. Relief valve assembly 52 may be configured to inhibit the flow of fuel in a reverse direction while fuel passes through enable valve 50 to engine 14. While the position of enable valve 50 illustrated in FIG. 2 inhibits the flow of fuel to regeneration assembly 36, it permits fuel supply circuit 48 to be connected to fuel return flow passage 54. Fuel return flow passage 54 may merge with fuel return line 28.

Fuel supply circuit 48 may include one or more valves, such as on/off valves. For example, in the exemplary embodiment illustrated in FIGS. 1 and 2, main on/off valve 56 and pilot on/off valve 58 are illustrated. Main and pilot on/off valves 56 and 58 may be any of various valves capable of suitably moving between an open position and a closed position such that flow of fluid through the valves is either on or off. For example, main and pilot on/off valves 56 and 58 may be suitable pulse width modulated (PWM) valves. Alternatively, suitable proportional valves may be employed in lieu of on/off valves.

In FIGS. 1 and 2, main on/off valve 56 may be within a main flow passage 60, and pilot on/off valve 58 may be within a pilot flow passage 62. Pilot flow passage 62 and pilot on/off valve 58 may facilitate the delivery of a pilot fuel injection by fuel injector unit 40 to assist in initiating combustion, for example. Main flow passage 60 and main on/off valve 56 may facilitate the delivery of a main fuel injection by fuel injector unit 40 to sustain combustion, for example. Within main flow passage 60, a suitable diagnostic device 64 may be provided to monitor a suitable parameter in main flow passage 60 such as, for example, pressure. Similarly, within pilot flow passage 62, a suitable diagnostic device 66 may be provided to monitor a suitable parameter in pilot flow passage 62 such as, for example, pressure. Main and pilot on/off valves 56, 58, and both diagnostic devices 64, 66, may communicate with controller 82 via a suitable communication line.

Regeneration assembly 36 may operate intermittently in regeneration cycles to perform regeneration of filter assembly 30. Between regeneration cycles, fuel may lie within components of the fuel supply circuit 48, such as fuel flow passages, valves, and injector unit 40. In accordance with an exemplary disclosed embodiment, injector unit 40 and/or fuel supply circuit 48 may be purged of fuel. Purging of injector unit 40 and/or fuel supply circuit 48 may be accomplished by supplying gas, such as air, to the injector unit 40 and/or to fuel supply circuit 48.

In the exemplary embodiment illustrated in FIGS. 1 and 2, a gas source 68 may be provided. Gas source 68 may be any suitable gas source. For example, gas source 68 may be an air pump, the engine air intake system of a machine, such as machine 10, associated with the regeneration assembly, a compressor, or any other suitable gas source. Gas source 68 may include the compressor of an associated machine, such as machine 10, otherwise employed to delivered compressed air to machine components. For example, gas source 68 may be the brake compressor of a machine air brake system, such as the air brake system of an on-highway truck. Air source 68 may be an air pump or compressor driven by the engine of an associated machine or driven by a separate motor. Gas source 68 may serve as a source of purge air to facilitate purging fuel injector unit 40 and/or fuel supply circuit 48.

Gas source 68 may deliver purge air to fuel injector unit 40 and/or fuel supply circuit 48 via gas flow path 70. Downstream of gas source 68, and within gas flow path 70, a suitable filter/accumulator 72 may be provided. Gas flow path 70 may make suitable connection to fuel injector unit 40 or fuel supply circuit 48. In the exemplary embodiment illustrated in FIGS. 1 and 2, gas flow path 70 may comprise branches 74 and 76 which may connect, respectively, to main flow passage 60 and pilot flow passage 62 proximate regeneration assembly 36 and fuel injector unit 40. Check valves 78 and 80 may be provided, respectively, in branches 74 and 76 to inhibit the flow of fuel into gas flow path 70.

Filter/accumulator 72 may remove undesired contaminants from purge air or gas and enable delivery of relatively uncontaminated air or gas to fuel injector unit 40 and/or fuel supply circuit 48. In addition, filter accumulator 72 may add volume to gas flow path 70 and serve as a pressure accumulator when gas source 68 is enabled. The volume of filter/accumulator 72 may be sized as a function of the volume of fuel supply circuit 48. For example, in an exemplary embodiment, the volume of filter/accumulator 72 may be sized to be approximately twice the volume of fuel supply circuit 48. Suitably sizing filter/accumulator 72 relative to fuel supply circuit 48 may permit pressure to build sufficiently within fuel supply circuit 48 during a purging cycle.

Various machine components, including regeneration assembly 36, filter assembly 30, fuel supply circuit 48, and components associated with the supply of purge gas, may be monitored and controlled by a suitable controller, such as controller 82. In the exemplary embodiment illustrated in FIGS. 1 and 2, controller 82 may be connected by suitable lines (illustrated as dotted lines) to the various diagnostic devices, valves, and other components to be monitored and/or controlled. Controller 82 may include a computer supplied with suitable algorithms, programs, and/or control strategies designed to effectuate efficient operation of machine and system components.

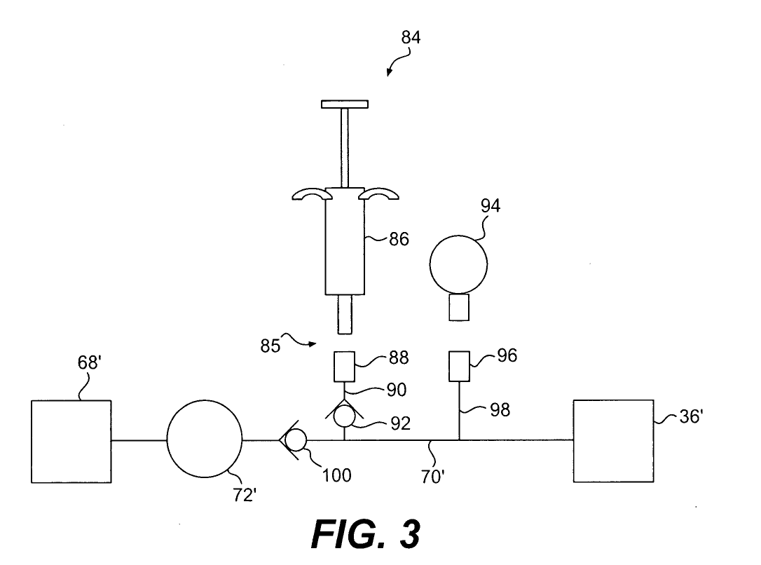

An exemplary embodiment suitable for cleaning fuel supply and fuel injecting components is schematically and diagrammatically illustrated in FIG. 3. FIG. 3 illustrates a cleaning system 84. Associated with cleaning system 84 is a regeneration assembly 36′. Regeneration assembly 36′ may be the same as or similar to the regeneration assembly 36 in the exemplary embodiment of FIGS. 1 and 2. In other words, regeneration assembly 36′ may be associated with an exhaust system in a suitable machine, and may include a combustion chamber and associated fuel supply components such as a fuel supply circuit and one or more fuel injector units as described in connection with the embodiment of FIGS. 1 and 2.

Cleaning system 84 may be employed where circumstances dictate that fuel supply components, such as a fuel supply circuit and/or one or more fuel injector units, may benefit from exposure to a suitable cleaning substance, such as cleaning fluid, solvent, or solution. Cleaning system 84 may include an assembly 85 that may include a suitable service tool 86 for delivering a quantity of a suitable cleaning fluid, solvent, or solution to fuel supply components. FIG. 3 illustrates gas source 68′, gas flow path 70′, and filter/accumulator 72′, all of which may be identical to or similar to the gas source 68, gas flow path 70, and filter 72 described in connection with the embodiment of FIGS. 1 and 2.

Connected to gas flow path 70′, in assembly 85, may be a suitable port adapter such as cleaning port 88. The port adapter may form a connection configured to enable service tool 86 to be attached to a supply line, such as flow passage 90. The supply line may include a check valve, such as check valve 92. Check valve 92 may facilitate one-way flow of cleaning fluid into gas flow path 70′, and prevent backflow. Service tool 86 may be any suitable tool enabling the introduction of a suitable cleaning substance into gas flow path 70′. For example, in the exemplary embodiment illustrated in FIG. 3, service tool 86 may be a syringe capable of dispensing a measured amount of cleaning substance under manual control by an operator. It will be understood that service tool 86 may include other types of devices or instruments capable of dispensing cleaning substance. It will also be understood that service tool 86 may be designed to dispense cleaning substance under manual control, or by control mechanisms within the service tool.

A suitable pressure monitoring device such as a pressure gauge 94 may be employed to ascertain pressure within gas flow path 70′. Pressure gauge 94 may be suitably coupled to a gauge port 96 which may be connected to gas flow path 70′ via a short flow passage, such as flow passage 98. A check valve 100 may be located in gas flow path 70′ upstream of the location of introduction of cleaning fluid into gas flow path 70′. Check valve 100 may effectively preclude the flow of cleaning fluid in a direction toward filter 72′ and gas source 68′.

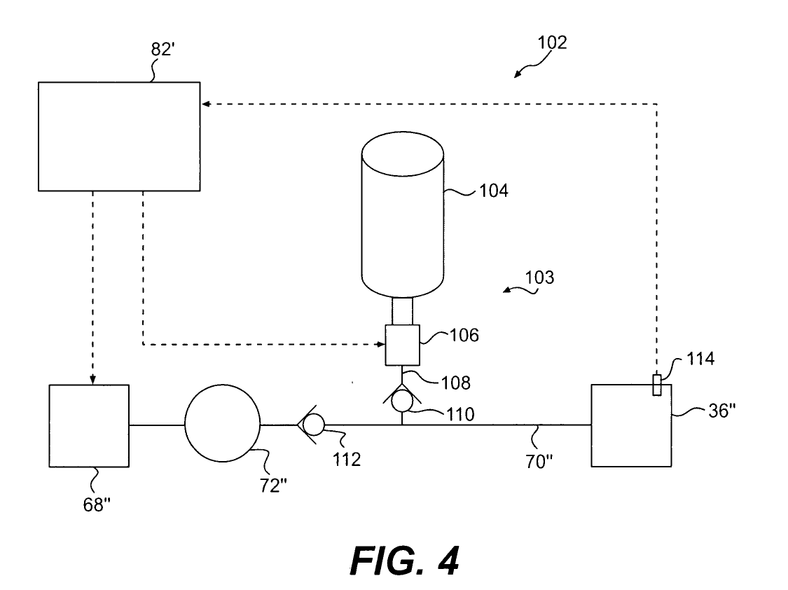

Another exemplary embodiment suitable for cleaning fuel supply and fuel injecting components is schematically and diagrammatically illustrated in FIG. 4. FIG. 4 illustrates a cleaning system 102. Associated with cleaning system 102 is a regeneration assembly 36″. Regeneration assembly 36″ may be the same as or similar to the regeneration assemblies 36 and 36′ in the exemplary embodiments of FIGS. 1, 2, and 3. In other words, regeneration assembly 36″ may be associated with an exhaust system in a suitable machine, and may include a combustion chamber and associated fuel supply components such as a fuel supply circuit and one or more fuel injector units.

In a manner similar to cleaning system 84 in the exemplary embodiment illustrated in FIG. 3, cleaning system 102 in the exemplary embodiment of FIG. 4 may be employed where circumstances dictate that fuel supply components such as a fuel supply circuit and/or one or more fuel injector units may benefit from exposure to a suitable cleaning substance, such as cleaning fluid, solvent, or solution. Cleaning system 102 may include an assembly 103 that may include a suitable supply container 104 for delivering a quantity of a suitable cleaning substance to the fuel supply components. In the embodiment of FIG. 4, gas source 68″, gas flow path 70″, and filter/accumulator 72″ may be identical to or similar to the gas source 68, 68′, gas flow path 70, 70′, and filter/accumulator 72, 72′ described in connection with the embodiments of FIGS. 1, 2, and 3.

A suitable valve, such as metering valve 106, may be associated with supply container 104. Supply container 104 and metering valve 106 may be connected to gas flow path 70″ by a short flow passage or supply line, such as flow passage 108, which may include a suitable check valve, such as check valve 110. Check valve 110 may facilitate one-way flow of cleaning fluid into gas flow path 70″. Metering valve 106 may include a suitable connection configured to enable the supply container 104 to be attached to the supply line. Alternatively, the connection may be separate from the metering valve.

Supply container 104 may be any suitable supply container enabling the introduction of a suitable cleaning substance into gas flow path 70″. For example, in the exemplary embodiment illustrated in FIG. 4, supply container 104 may be a pressure container configured to contain cleaning fluid under pressure. Supply container 104 may be designed to be readily replaced, for example, for one-time use, and may be designed to contain a measured quantity of cleaning fluid. For example, supply container 104 may be a pressure container configured and sized to hold 18 ounces of liquid.

A check valve 112 may be located in gas flow path 70″ upstream of the location of introduction of cleaning fluid into gas flow path 70″. Check valve 112 may effectively preclude the flow of cleaning fluid in a direction toward filter/accumulator 72″ and gas source 68″.

In the exemplary embodiment illustrated in FIG. 4, the introduction of cleaning substance into gas flow path 70″ may be implemented under a control strategy. A suitable controller 82′, identical to or similar to controller 82 in the embodiment of FIGS. 1 and 2, may control the introduction of cleaning substance according to a timed control strategy, or in response to an indication that a fuel supply circuit and/or a fuel injector unit may benefit from contact with cleaning substance. One or more diagnostic devices, such as diagnostic device 114, may be associated with regeneration assembly 36″, and configured to monitor one or more parameters indicative that a cleaning cycle may be beneficial. For example, diagnostic device 114 may monitor temperature and/or pressure either within the regeneration assembly 36″ or in the fuel supply circuit supplying fuel to the regeneration assembly 36″. Controller 82′ may determine when cleaning supply container 104 is empty by counting the number of cleaning events performed or by monitoring a suitable diagnostic device, for example. Data gathered and conditions sensed by diagnostic device 114 may be relayed to controller 82′ via a suitable communication line.

Controller 82′ may be suitably connected to gas source 68″ and to metering valve 106 via suitable communication lines. Lines connecting controller 82′ to diagnostic device 114, gas source 68″, and metering valve 106 are indicated in FIG. 4 as dotted lines. Controller 82′ may implement various control strategies for cleaning fuel supply circuit components. For example, controller 82′ may be suitably programmed to implement a cleaning cycle after a predetermined number of regeneration cycles. For example only, controller 82′ could implement a cleaning cycle, including introduction of cleaning substance, after ten regeneration cycles. In addition, controller 82′ could implement a cleaning cycle responsive to feedback from diagnostic device 114 indicating that fuel supply circuit components could benefit from a cleaning cycle regardless of the number of regeneration cycles that have occurred.

Referring collectively to FIG. 3 and to FIG. 4, a cleaning cycle may include a number of events. For example, prior to introduction of cleaning substance either by service tool 86 in the exemplary embodiment of FIG. 3, or by supply container 104 in the exemplary embodiment of FIG. 4, gas source 68′, 68″ may be activated to at least partially purge fuel from fuel supply circuit components, including the fuel injector unit and/or the fuel supply circuit associated with regeneration assembly 36″. In addition, subsequent to introduction of cleaning substance in either of the exemplary embodiments of FIGS. 3 and 4, gas source 68′, 68″ may be activated to at least partially purge cleaning substance from gas flow path 70′, 70″, as well as from the fuel injector unit and/or the fuel supply circuit associated with regeneration assembly 36′, 36″

It should be understood that the exemplary embodiment of FIG. 3 may be associated with and may be a component of the exemplary embodiment of FIGS. 1 and 2. Similarly, the exemplary embodiment of FIG. 4 may be associated with and may be a component of the exemplary embodiment of FIGS. 1 and 2. In other words, the embodiments of FIGS. 1 and 2 on the one hand, and FIG. 3 and FIG. 4 on the other hand, are not mutually exclusive. Rather, the cleaning system illustrated in FIG. 3 or in FIG. 4 may be employed to introduce cleaning fluid into the fuel supply circuit components of the embodiment of FIGS. 1 and 2. Referring to FIGS. 1 and 2, for example, arrow 116 designates an exemplary location along gas flow path 70 at which assembly 85 including service tool 86 and associated components 88, 90, and 92 of FIG. 3 could be conveniently accommodated. Similarly, assembly 103 including supply container 104, metering valve 106 and associated components 108 and 110 of FIG. 4 likewise could be accommodated at the location designated by arrow 116.

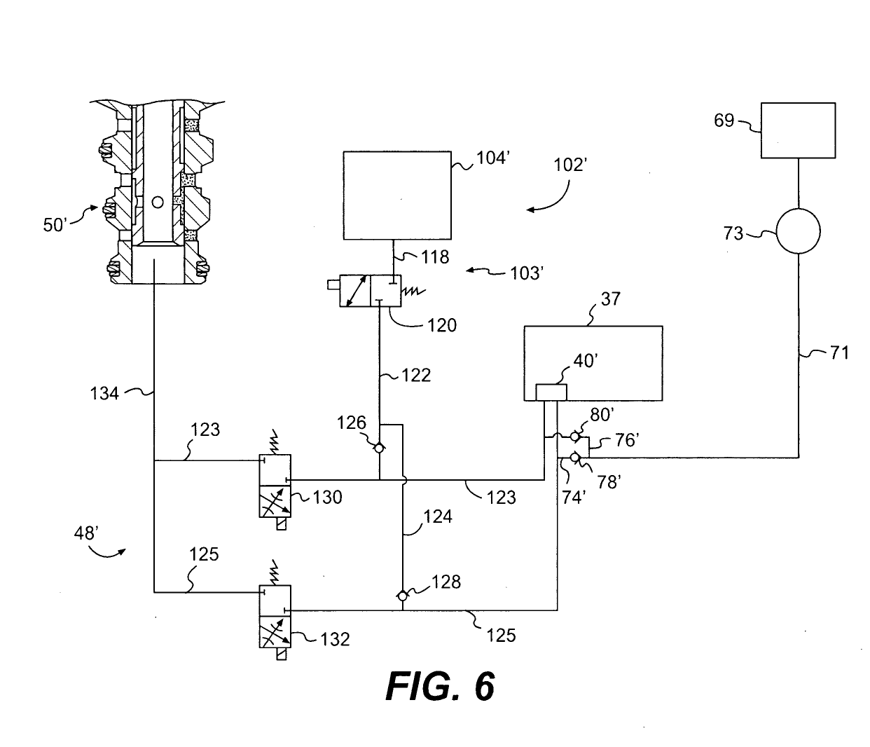

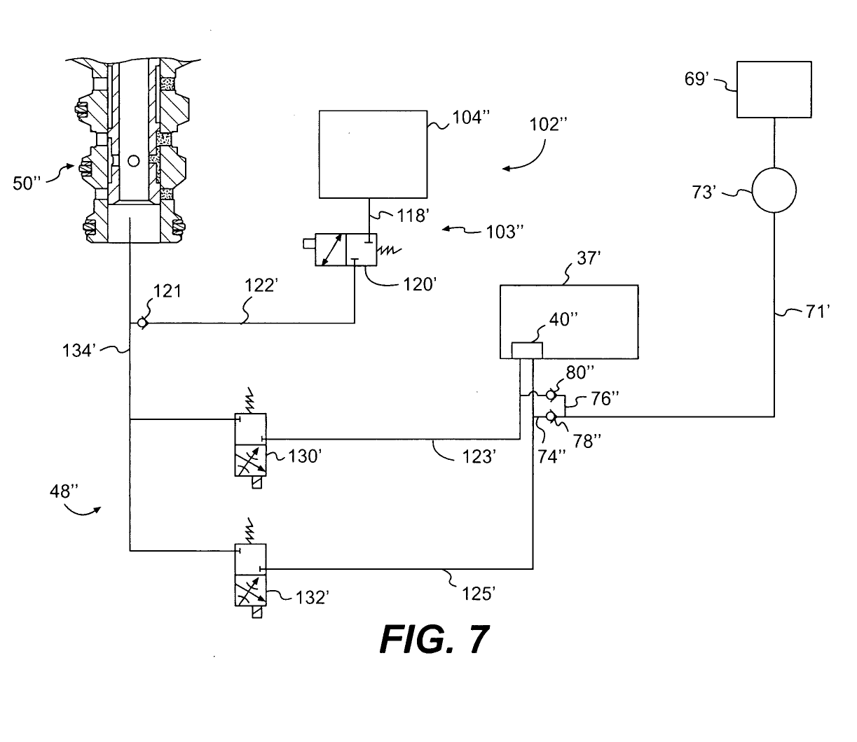

FIGS. 6 and 7 schematically and diagrammatically illustrate other exemplary embodiments suitable for cleaning fuel supply and fuel injecting components. In the exemplary embodiments illustrated in FIGS. 6 and 7, provision is made for introducing a suitable cleaning substance directly into a fuel flow path that directs fuel to a fuel injector unit of a regeneration assembly. While FIGS. 6 and 7 have been illustrated with some components that are the same as or similar to those illustrated in FIGS. 1 and 2, other components have been omitted in FIGS. 6 and 7 in the interest of clarity of illustration.

FIG. 6 illustrates a cleaning system 102′. Associated with cleaning system 102′ is a regeneration assembly 37. Regeneration assembly 37 may be the same as or similar to the regeneration assemblies 36, 36′, and 36″ in the exemplary embodiments of FIGS. 1-4. In other words, regeneration assembly 37 may be associated with an exhaust system in a suitable machine, and may include a combustion chamber and associated fuel supply components such as a fuel supply circuit and one or more fuel injector units. In the embodiment illustrated in FIG. 6, the cleaning system 102′ is configured to introduce a suitable cleaning substance directly into a flow passage of fuel supply circuit 48′ at some point between enable valve 50′ and regeneration assembly 37.

In a manner similar to cleaning system 84 in the exemplary embodiment illustrated in FIG. 3 and cleaning system 102 in the exemplary embodiment illustrated in FIG. 4, cleaning system 102′ in the exemplary embodiment of FIG. 6 may be employed where circumstances dictate that fuel supply components such as a fuel supply circuit and/or one or more fuel injector units may benefit from exposure to a suitable cleaning substance, such as cleaning fluid, solvent, or solution. Cleaning system 102′ may include an assembly 103′ that may include a suitable supply container 104′ for delivering a quantity of a suitable cleaning substance to the fuel supply components.

In the embodiment of FIG. 6, gas source 69, gas flow path 71, and filter/accumulator 73 may be identical to or similar to the gas source 68, 68′, 68″, gas flow path 70, 70′, 70″, and filter/accumulator 72, 72′, 72″ described in connection with the embodiments of FIGS. 1-4. Gas flow path 71 may branch for connection to both a fuel flow passage 123, via branch 76′ and a suitable check valve 80′, and a fuel flow passage 125, via branch 74′ and a suitable check valve 78′. In this way, gas, such as air, from gas source 69 may effectively flow, either continuously or intermittently, to fuel injection unit 40′ during those time when fuel is not being supplied to fuel injection unit 40′.

A suitable valve 120 may be associated with supply container 104′. Supply container 104′ may be connected to valve 120 via a flow passage 118. Valve 120 may be chosen from among various suitable valves capable of controlling the supply of a cleaning substance from supply container 104′ to the fuel supply circuit 48′. For example, valve 120 may be a suitable solenoid operated on/off valve as illustrated in FIG. 6. Downstream of valve 120, suitable flow passages 122, 124 may provide a path for the cleaning substance to flow between valve 120 and pilot and main fuel flow passages 123, 125. Suitable check valves, such as check valves 126, 128, may be provided in flow passages 122, 124.

Supply container 104′ may be any suitable supply container enabling the introduction of a suitable cleaning substance into pilot and main flow passages 123, 125. For example, in the exemplary embodiment illustrated in FIG. 6, supply container 104′ may be a pressurized container configured to contain cleaning fluid under pressure. Supply container 104′ may be designed to be readily replaced, for example, for one-time use, and may be designed to contain a measured quantity of cleaning fluid.

In the exemplary embodiment illustrated in FIG. 6, the introduction of cleaning substance into the fuel supply circuit 48′ may be implemented under a control strategy. A suitable controller, not shown in FIG. 6 but identical to or similar to controller 82 in the embodiment of FIGS. 1 and 2, may control the introduction of cleaning substance according to a timed control strategy, or in response to an indication that a fuel supply circuit and/or a fuel injector unit may benefit from contact with cleaning substance. One or more diagnostic devices, not shown, but identical to or similar to the diagnostic device 114 illustrated in the embodiment of FIG. 4, may be associated with regeneration assembly 37, and configured to monitor one or more parameters indicative that a cleaning cycle may be beneficial. The controller may determine when cleaning supply container 104′ is empty by counting the number of cleaning events performed or by monitoring a suitable diagnostic device, for example. Data gathered and conditions sensed by the diagnostic device may be relayed to the controller via a suitable communication line, also not shown in FIG. 6.

In FIG. 6, fuel may be selectively permitted to flow to the fuel supply circuit 48′ from a source (not shown in FIG. 6) via enable valve 50′. Enable valve 50′ may be the same as or similar to enable valve 50 in the embodiment of FIGS. 1 and 2. From enable valve 50′, fuel may flow through flow passage 134 to subsequent pilot and main flow passages 123 and 125. Pilot flow passage 123 may include proportional valve 130 and main flow passage 125 may include proportional valve 132. Pilot flow passage 123 may direct fuel to a pilot injector within fuel injector unit 40′ and main flow passage 125 may direct fuel to a main injector within fuel injector unit 40′. Proportional valve 130 may control flow through pilot flow passage 123, while proportional valve 132 may control flow through main flow passage 125. While proportional valves 130, 132 may be selected from among various proportional valves known in the art, proportional valves 130 and 132 may be, for example, two-way solenoid activated proportional valves as diagrammatically illustrated in FIG. 6.

As illustrated in FIG. 6, cleaning substance may be introduced into pilot and main flow passages 123, 125 downstream of proportional valves 130, 132. When it is desired to introduce cleaning substance from container 104′ into pilot and main flow passages 123, 125, the controller may activate the valve 120 to permit cleaning substance to be admitted from the pressurized container 104′. In an alternative embodiment, cleaning substance may be introduced into pilot and main flow passages 123, 125 with a service tool similar to or the same as that disclosed in connection with the embodiment illustrated in FIG. 3.

FIG. 7 illustrates a cleaning system 102″. Associated with cleaning system 102″ is a regeneration assembly 37′. Regeneration assembly 37′ may be the same as or similar to the regeneration assemblies 36, 36′, 36″, and 37 in the exemplary embodiments of FIGS. 1-4 and 6. In other words, regeneration assembly 37′ may be associated with an exhaust system in a suitable machine, and may include a combustion chamber and associated fuel supply components such as a fuel supply circuit and one or more fuel injector units. In the embodiment illustrated in FIG. 7, the cleaning system 102″ is configured to introduce a suitable cleaning substance directly into a flow passage of fuel supply circuit 48″ at a point between enable valve 50″ and regeneration assembly 37′.

In connection with the exemplary embodiment illustrated in FIG. 7, it should be noted that it differs from the exemplary embodiment illustrated in FIG. 6 as to the general location at which cleaning substance may be introduced into the fuel passages. Otherwise, the embodiment illustrated in FIG. 7 may be essentially similar to that illustrated in FIG. 6. It should be noted that most reference numerals provided in FIG. 7 are essentially the same as those provided in FIG. 6, except that each reference numeral in FIG. 7 is primed or double primed relative to those in FIG. 6. An understanding of the operation of the exemplary embodiment of FIG. 7 will be apparent from the above description of other embodiments, and from the following description.

Referring to FIG. 7, during a cleaning cycle, cleaning substance may be supplied from container 104″ through flow passage 118′, valve 120′, and flow passage 122′ to fuel flow passage 134′. From fuel flow passage 134′, cleaning substance may pass through pilot flow passage 123′ and valve 130′ to a pilot nozzle within fuel injector assembly 40″, and cleaning substance may pass through main flow passage 125′ and valve 132′ to a main nozzle within fuel injector assembly 40″.

In the exemplary embodiment illustrated in FIG. 7, the introduction of cleaning substance into the fuel supply circuit 48″ may be implemented under a control strategy. A suitable controller, not shown in FIG. 7 but identical to or similar to controller 82 in the embodiment of FIGS. 1 and 2, may control the introduction of cleaning substance according to a timed control strategy, or in response to an indication that a fuel supply circuit and/or a fuel injector unit may benefit from contact with cleaning substance. One or more diagnostic devices, not shown, but identical to or similar to the diagnostic device 114 illustrated in the embodiment of FIG. 4, may be associated with regeneration assembly 37′, and configured to monitor one or more parameters indicative that a cleaning cycle may be beneficial. The controller may determine when cleaning supply container 104″ is empty by counting the number of cleaning events performed or by monitoring a suitable diagnostic device, for example. Data gathered and conditions sensed by the diagnostic device may be relayed to the controller via a suitable communication line, also not shown in FIG. 7.

In FIG. 7, fuel may be selectively permitted to flow to the fuel supply circuit 48″ from a source (not shown in FIG. 7) via enable valve 50″. Enable valve 50″ may be the same as or similar to enable valves 50, 50′ in the embodiment of FIGS. 1, 2, and 6. From enable valve 50″, fuel may flow through flow passage 134′ to subsequent pilot and main flow passages 123′ and 125′. Pilot flow passage 123′ may include proportional valve 130′ and main flow passage 125′ may include proportional valve 132′. Pilot flow passage 123′ may direct fuel to a pilot injector within fuel injector unit 40″ and main flow passage 125′ may direct fuel to a main injector within fuel injector unit 40″. Proportional valve 130′ may control flow through pilot flow passage 123′, while proportional valve 132′ may control flow through main flow passage 125′. Although proportional valves 130′, 132′ may be selected from among various proportional valves known in the art, proportional valves 130′ and 132′ may be, for example, two-way solenoid activated proportional valves as diagrammatically illustrated in FIG. 7.

As illustrated in FIG. 7, cleaning substance may be introduced into flow passage 134′ upstream of proportional valves 130′, 132′. When it is desired to introduce cleaning substance from container 104″ into flow passage 134′, the controller may activate the valve 120′ to permit cleaning substance to be admitted from the pressurized container 104″. Proportional valve 130′ and proportional valve 132′ may be selectively activated by the controller, for example. Selective actuation of valves 130′, 132′ may permit cleaning substance to be selectively supplied to a pilot injection nozzle and a main injection nozzle. For example, the controller may determine, based on feedback from a suitable diagnostic device, that only one of the main and pilot nozzles may require cleaning. In such a situation, the controller may command selective actuation of only the valve 130′, 132′ associated with the affected nozzle. In an alternative embodiment, cleaning substance may be introduced into flow passage 134′ with a service tool similar to or the same as that disclosed in connection with the embodiment illustrated in FIG. 3.

### INDUSTRIAL APPLICABILITY

The disclosed embodiments may be used to facilitate effective and efficient regeneration of a filter by a regeneration assembly, such as regeneration assembly 36, 36′, 36″. Filters which may be regenerated may include any type of filters known in the art which are capable of being regenerated, such as, for example, particulate filters useful in extracting pollutants from a flow of fluid. Such filters, and thus, the regeneration assembly 36, 36′, 36″, may be fluidly connected to an exhaust outlet of, for example, a diesel engine, gasoline engine, or other power source generating a flow of exhaust.

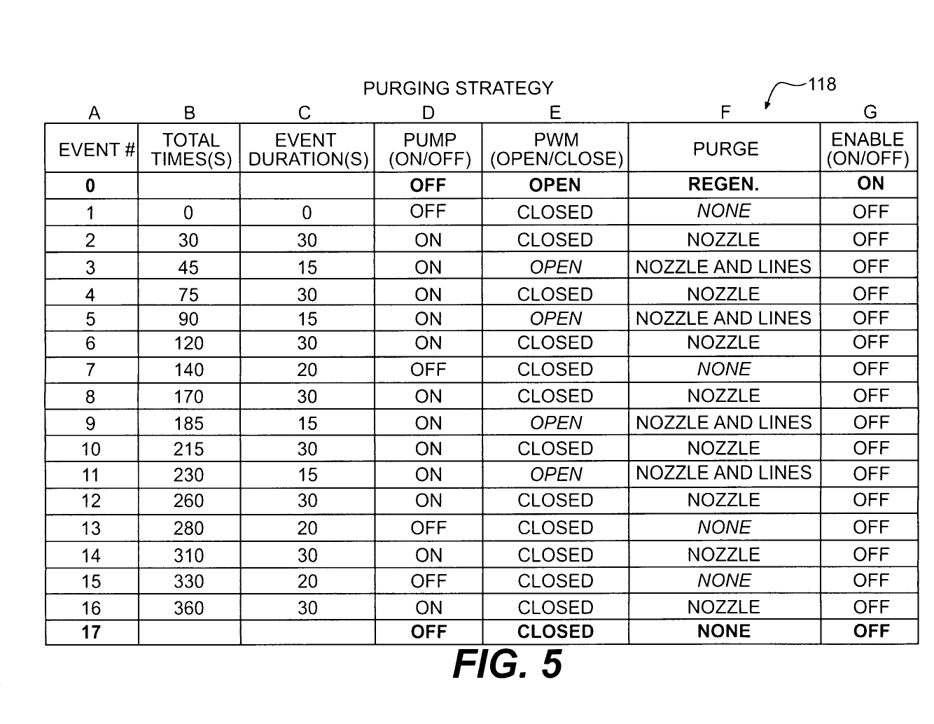

FIG. 5 illustrates a table 118 that may assist in understanding an exemplary strategy for purging fuel supply circuit components associated with a regeneration assembly 36, 36′, 36″, during a purging cycle. Table 118 is illustrated with vertical columns A-G, to be explained more fully below, and horizontal rows corresponding to a sequence of events. FIG. 5 is exemplary, and not limiting. Numerous and various control strategies designed to extend fuel injector unit life and fuel supply circuit life, and extend the time between component cleaning and maintenance, are contemplated within the scope of this disclosure.

Referring to FIG. 5 and table 118, column A designates a sequence of events. At event 0, a regeneration cycle is in progress, and fuel is supplied to the fuel supply circuit 48 and fuel injector unit 40, referring to the embodiment of FIGS. 1 and 2. As can be seen from column D, the pump (referring to an embodiment of gas source 68) is off, and no purging gas is flowing. Column E indicates that the PWM valve (referring to one embodiment of on/off valves 56, 58) is open, and column G indicates that enable (enable valve 50, for example) is on, both together indicating that fuel is flowing through fuel supply circuit 48 to fuel injector unit 40. At the onset of a regeneration cycle, enable valve 50 may be moved to the position illustrated in FIG. 1, permitting fuel to be supplied from fuel source 22 to the combustion chamber of regeneration assembly 36. Column F indicates that regeneration is in progress (i.e., no purge, regeneration active).

The exemplary purging strategy indicated by table 118 illustrates sixteen events numbered 1-16 in a purging cycle. Event 17 designates the end of the purging cycle. Event 1 occurs after a regeneration cycle at time 0. Pump (gas source) is off, PWM (on/off valve(s)) is closed, and enable (enable valve 50) is off. Enable off indicates that enable valve 50 is in the position indicated in FIG. 2 wherein fuel supply circuit 48 is connected to return line 54, and fuel pump 24 is not delivering fuel to fuel supply circuit 48. At the onset of a purging cycle, enable valve 50 may be moved to the position indicated in FIG. 2 inhibiting fuel from being supplied from the fuel source 22 to the combustion chamber, and permitting fuel to flow from the fuel supply circuit 48 toward the fuel source 22. Event 1 may be of only a duration sufficient to achieve PWM closed and enable off.

Event 2 may occur immediately after event 1. At event 2, pump (gas source) is on, indicating that purging gas is flowing into gas flow path 70 and toward the connection of branches 74, 76 with main flow passage 60 and pilot flow passage 62, referring to FIG. 2. During event 2, filter/accumulator 72 is charged to a suitable pressure as gas source 68 is enabled. The pressure to which filter/accumulator 72 is charged may be a function of the gas flow rate from source 68 and the flow area of the fuel injector unit 40. In other words, the pressure to which filter/accumulator 72 is charged may be greater with a greater flow rate from source 68, and greater with decreased flow area of fuel injector unit 40.

It will be understood that, although filter/accumulator 72, 72′, 72′ has been illustrated and described as a single element or component, it is contemplated that the filter and the accumulator could, in fact, be separate and distinct components. Accordingly, it will be understood that where reference is made to the filter/accumulator in a filtering capacity, it could be a filter alone, and where reference is made to the filter/accumulator in its accumulator capacity, it could be an accumulator alone.

Column E indicates that PWM (main on/off valve 56 and pilot on/off valve 58) is/are closed, and column G indicates that enable (enable valve 50) remains off, or in the position illustrated in FIG. 2. Because PWM is closed, gas from gas source 68 cannot flow through fuel supply circuit 48 toward enable valve 50 and fuel source 22. Instead, gas from gas source 68 is forced through fuel injector unit 40 and intervening supply lines to purge fuel injector unit 40 of fuel. The purged fuel may be forced into regeneration assembly 36. Column F indicates nozzle purge (a fuel injection unit usually including one or more nozzles) during event 2. Event 2 may be designated a fuel injector unit purging event and may have a duration of 30 seconds as indicated by column C.

Event 3 may occur immediately following event 2, with a duration of 15 seconds. At event 3, pump remains on and enable remains off, but PWM is open. PWM open, referring to FIG. 2, indicates that main on/off valve 56 and pilot on/off valve 58 are open. Because PWM is open, gas from gas source 68 is permitted to flow through fuel supply circuit 48, through enable valve 50, through return passage 54 and to fuel source 22. In the embodiment illustrated in FIGS. 1 and 2, a suitable check valve, such as check valve 55, may be disposed in return line 28 to inhibit gas and/or fuel flow through return line 28 and toward engine 14. Similarly, a suitable check valve, such as check valve 57, may be disposed in return flow passage 54 to inhibit backflow from fuel return line 28 through fuel supply circuit 48. Thus, during event 3, fuel within fuel injector unit 40 is purged, and fuel supply circuit 48 (usually including one or more fuel lines) is purged toward fuel source 22. Event 3 may be designated a fuel injector unit and fuel supply circuit purging event.

During event 3, filter/accumulator 72, discharges accumulated pressure at a rate that is a function of the flow area of fuel supply circuit 48 and return flow passage 54 through which gas may flow (an area likely much greater than the flow area of fuel injector unit 40). During event 3, the system pressure may drop rapidly as a function of the gas flow rate from gas source 68, particularly if the available flow rate is minimal, as may be the case where an electrically driven air pump is the gas source 68. Effectiveness of purging fuel back to fuel source 22 may be increased by higher flow rates and reduced volume/cross-sectional area of the fuel supply and return lines (e.g., 60, 62, 54, etc.).

System design may be optimized to reduce fuel line size with a view toward improving the purging process. The accumulator volume within filter/accumulator 72 may provide an instantaneous flow rate exceeding available flow from, for example, an electrically operated pump, to further improve the purging process. Shortly after event 3 is initiated, system pressure rapidly drops after the filter/accumulator 72 is discharged. According to an exemplary disclosed purging strategy, the process may be repeated.

Events 4, 6, 8, 10, 12, 14, and 16 are substantial repetitions of event 2 wherein the fuel injector unit 40 (nozzle) is purged, but fuel supply circuit 48 is not purged. Events 5, 9, and 111 are substantial repetitions of event 3 wherein the fuel supply circuit 48 is purged back toward fuel tank 22, while fuel injector unit 40 is simultaneously purged into regeneration assembly 36. Events 7, 13, and 15 are substantial repetitions of event 1 wherein pump (gas source 68) is off, PWM is closed, and enable is off, resulting in hiatus events where no purging occurs. Under the exemplary control strategy of FIG. 5, a purging cycle would have a total duration 360 seconds, or six minutes. It is understood that this time duration is exemplary and not limiting.

The most suitable sequence of events within a purging cycle, and the duration of each event, may be empirically determined for a particular regeneration assembly fuel supply system. Fuel may not completely purge with ease from the various spaces that may, in reality, occur in a fuel system. Bends and connections within fuel lines, the length of lines to be purged, and spaces peculiar to valve and injector structure may work against adequate purging in a single purge event. Accordingly, a purging strategy wherein a purging cycle includes a sequence of timed events, as exemplified by the purging strategy illustrated in FIG. 5 and described above, may effectively and efficiently purge fuel injector unit 40 and/or fuel supply circuit 48, extend fuel supply circuit component life, and reduce maintenance and downtime.

The exemplary control strategy illustrated by table 118 of FIG. 5 may be implemented by controller 82, for example, referring to FIGS. 1 and 2. Controller 82 may include a suitable computer, programmed to implement the control strategy of FIG. 5 as well as various other control strategies. FIGS. 1 and 2 include dotted lines between controller 22 and various components, such as gas source 68, main and pilot on/off valves 56, 58, and diagnostic devices 34, 46, 64, and 66. Thus, controller 82 may control gas source 68 (pump in FIG. 5), main and pilot on/off valves 56, 58 (PWM in FIG. 5) and enable valve 50 (enable in FIG. 5), in implementing a control strategy, such as the exemplary control strategy illustrated in FIG. 5.

Controller 82 may direct a purging cycle, including one or more events, after engine shutdown and/or shortly after engine start-up. In addition, controller 82 may direct a purging cycle, including one or more events, at a controlled duty cycle. For example, the purging cycle illustrated in table 118 in FIG. 5 may be implemented for 6 minutes after a regeneration cycle has ended. Then, purging of fuel injector unit 40 and/or fuel supply circuit 48 may be implemented for 30 seconds, every 5 minutes after the strategy illustrated in FIG. 5 has been implemented. Other implementations of a controlled duty cycle are contemplated to be within the scope of the disclosure.

Controller 82 may direct a purging cycle at a time sooner than otherwise scheduled and programmed where diagnostic devices monitoring pressure indicate that pressure from gas source 68, for example, may have been below a predetermined minimum pressure, and thus too low during a previous purging cycle for reliably sufficient purging. When such an indication occurs during a purging cycle, a pressure deficiency flag may be initiated in controller 82 to adjust the timing for the next purging cycle. This may occur, for example, where gas source 68 is a compressor for a brake system of a machine, and the compressor was subjected to heavy demand by the brake system during a previous purging cycle.

Referring to FIGS. 1 and 2 in concert with FIGS. 3, 4, 6, and 7, a strategy may be implemented for cleaning fuel supply system components, such as fuel injector unit 40, 40′, 40″. As previously described, the exemplary cleaning systems 84, 102, 102′, and 102″, illustrated in FIGS. 3, 4, 6, and 7, respectively, are not exclusive of the engine system and purging system illustrated in FIGS. 1 and 2 and described in connection with FIG. 5. The cleaning system of FIG. 3, or the cleaning system of FIG. 4, may be implemented in the system illustrated in FIGS. 1 and 2 at any suitable position along gas flow path 70 between filter 72 and connection to fuel injector unit 40 or fuel supply circuit 48, such as, for example, the position indicated by arrow 1116. Cleaning system 102′ and 102″, illustrated in FIGS. 6 and 7, respectively, may be implemented in the system illustrated in FIGS. 1 and 2 between the enable valve 50 and the regeneration assembly 36, as will be apparent from a comparison of the illustrations in FIGS. 6 and 7 with the illustrations in FIGS. 1 and 2.

In accordance with this disclosure, features described and illustrated in connection with FIGS. 3 and 4 are to be considered applicable to the embodiments described and illustrated in connection with FIGS. 6 and 7. While a supply container 104′, 104″ is illustrated somewhat diagrammatically in FIGS. 6 and 7, it will be understood that the supply container 104′, 104″ could, instead, be a service tool arrangement similar to that illustrated and described in connection with FIG. 3. One difference in implementation of a service tool and associated port adaptor in FIG. 6 would be that the cleaning substance would be introduced directly into a fuel flow line rather than into a gas flow line. Another difference would be that a solenoid activated on/off valve may be employed, as illustrated in FIG. 6. However, it will be understood that, where a service tool is the selected mode of supplying cleaning substance, the valve may be either eliminated or maintained in an open position, or a different type of valve (such as a manual valve) could be employed.

In an exemplary embodiment wherein a cleaning system, such as cleaning system 84 of FIG. 3, is implemented at exemplary position 116, a suitable cleaning strategy may be implemented. First, pressure gauge 94 may be installed at gauge port 96 in gas flow path 70, 70′. Once gauge 94 has been installed, gas source 68, 68′, which may include an air pump, for example, is activated for a time duration of 15 seconds. Once the 15 second duration has elapsed, an operator may wait for gauge pressure to drop substantially to zero, indicating that line pressure has diminished sufficiently to permit cleaning substance to be introduced.

When gauge pressure has reached substantially zero, an operator may introduce cleaning substance with, for example, a syringe or other service tool 86, capable of introducing a measured amount of cleaning substance. For example, 1.5 ounces of cleaning fluid may be introduced in a given cleaning cycle. After the cleaning fluid has been introduced, gas source 68 may be activated again for 15 seconds. By this strategy, fuel may first be purged from fuel injection unit 40, for example, cleaning fluid may then be introduced, and purging may once again occur to force cleaning fluid from lines leading to fuel injector unit 40 and through fuel injector unit 40, both to enhance cleaning and eliminate cleaning fluid and matter removed by the cleaning fluid from the lines and fuel injector unit 40.

In an exemplary embodiment wherein a cleaning system such as cleaning system 102 of FIG. 4 is implemented at exemplary position 116, a suitable cleaning strategy may be implemented. For example, after a regeneration cycle and a purge cycle (for example, a purge cycle similar to that of FIG. 5), controller 82, 82′ may activate metering valve 106 via a suitable control line to introduce a measured amount, for example 0.25 ounce, of cleaning fluid from supply container 104. Supply container 104 may be, for example, an 18 ounce pressure container. After introduction of this measured amount of cleaning fluid, controller 82, 82′ may then activate gas source 68, 68″, which may be an air pump, for a duration of 15 seconds.

In an exemplary embodiment wherein a cleaning system such as cleaning system 102′ (FIG. 6) or 102″ (FIG. 7) is implemented relative to a fuel flow passage, a suitable cleaning strategy may be implemented. For example, after a regeneration cycle and a purge cycle (for example, a purge cycle similar to that of FIG. 5), the controller (similar to controller 82, 82′) may activate valve 120, 120′ via a suitable control line to introduce a predetermine amount of cleaning substance from supply container 104′, 104″. Supply container 104′, 104″ may be, for example, a pressurized container configured to hold a convenient volume of cleaning substance. After introduction of this predetermined amount of cleaning substance, the controller may then activate gas source 69, 69′, which may be an air pump, for example, for a suitable duration. Alternatively, the controller may activate the gas source 69, 69′ to operate continuously while a cleaning cycle is not occurring and while fuel is not being supplied to fuel injector unit 40′, 40″.

In accordance with an exemplary embodiment, cleaning systems 84, 102, 102′, 102″ may be implemented as a kit in order to adapt an existing fuel supply system to incorporate a cleaning system, for example. Such a kit may include a device, such as service tool 86 or supply container 104, 104′, 104″, and a length of supply line for cleaning substance, such as 90, 108, 118, 118′. A kit also may include a suitable connection, such as port adapter 88, for example, configured to enable the device to be attached to the supply line. Where it may be desired to employ a pressurized container, such as supply container 104, 104′, 104″, a suitable connection for removably receiving such a container on a supply line may be included in the kit. A check valve or valves, such as check valves 92, 110, 121, 126, 128 also may be included in the kit. In addition, a suitable valve configured to be attached to a supply line to control the flow of cleaning substance, such as metering valve 106 or solenoid activated on/off valves 120, 120′, may be included in the kit.

By employing a kit, as described, a fluid flow line, such as a gas flow line 70, 70′, 70″, or fuel flow line 123, 124, 134, may be adapted for receiving a cleaning substance suitable for cleaning fuel supply components. A supply line, such as 90, 108, 118, 118′, 122, 124, 122′, may be connected to a gas flow line or a fuel flow line. A device configured to hold a quantity of cleaning substance, such as 86, 104, 104′, 104″, may be connected to the supply line. In addition, via a suitable device such as check valve 92, 110, 126, 128, 121, for example, cleaning substance may be permitted to flow to the fuel flow line or the gas flow line while reverse flow is prevented.

A fluid injection nozzle associated with an aftertreatment assembly may be suitably cleaned in accordance with exemplary disclosed embodiments. A suitable cleaning substance may be dispensed into a fluid flow path from a device, such as service tool 86 or pressurized supply container 104, 104′, 104″, during a cleaning cycle. The cleaning substance may be directed through the fluid flow path and through at least one fluid injection nozzle associated with the aftertreatment assembly. A valve, such as solenoid activated on/off valve 120, 120′, may be employed to selectively permit dispensing of the cleaning substance into the fluid flow path. In exemplary embodiments, a suitable check valve may be employed to prevent backflow toward the service tool or pressurized supply container.

A system and method have been described that will facilitate cleaning a fuel injector unit and associated components so as to eliminate undesirable deposits that accumulate due to the presence of fuel. It will be apparent to those having ordinary skill in the art that various modifications and variations can be made to the disclosed cleaning system and method without departing from the scope of the disclosure.

While exemplary embodiments have been disclosed in connection with cleaning fuel supply components, the disclosed system may be applicable to clean a liquid injection system in those exhaust aftertreatment systems that employ such a system. For example, the urea supply system in a Selective Catalytic Reduction (SCR) system also may be subject to deposits in its associated liquid handling/injection system. Such a system may benefit from a cleaning system implemented based on the teachings of this disclosure. An SCR system my include a nozzle for injecting urea, for example, into an exhaust system. Such a nozzle may become fouled and/or be subjected to a build-up of deposits, and may benefit from a purging system and/or cleaning system and appropriate purging and cleaning strategies in accordance with this disclosure.

Other embodiments will be apparent to those having ordinary skill in the art from consideration of the specification and practice of the disclosed embodiments. It is intended that the specification and examples be considered as exemplary only with the true scope of protection being indicated by the following claims.

What is claimed is:

1. A method, comprising:
operating a regeneration assembly to regenerate a filter assembly during a regeneration cycle;
supplying fuel through a fuel flow path to at least one fuel injector unit associated with the regeneration assembly during the regeneration cycle;
dispensing a cleaning substance into the fuel flow path during a cleaning cycle; and
directing the cleaning substance through the at least one fuel injector unit during the cleaning cycle.

2. The method of claim 1, further including:
dispensing the cleaning substance into the fuel flow path with a service tool.

3. The method of claim 1, further including:
prior to introducing the cleaning substance, pumping air through a fluid flow path and through the at least one fuel injector unit.

4. The method of claim 3, further including:
subsequent to introducing the cleaning substance, pumping air through the fluid flow path and through the at least one fuel injector unit.

5. The method of claim 1, further including:
activating an air pump via a controller to pump air through a fluid flow path and through the at least one fuel injector unit for a predetermined time before and/or after dispensing the cleaning substance.

6. The method of claim 1, including dispensing the cleaning substance from a pressurized container through a solenoid activated on/off valve.

7. The method of claim 1, further including:
monitoring at least one parameter indicative of whether fuel injection unit performance may benefit from dispensing a cleaning substance; and
dispensing the cleaning substance responsive to the monitored parameter indicating fuel injector unit performance may benefit from dispensing the cleaning substance.

8. The method of claim 1, wherein supplying fuel includes supplying fuel through at least one proportional valve, and wherein dispensing a cleaning substance includes dispensing the cleaning substance upstream of the at least one proportional valve.

9. The method of claim 8, wherein supplying fuel through at least one proportional valve includes selectively supplying fuel through a pilot proportional valve to a pilot injector of the at least one fuel injector unit, and selectively supplying fuel through a main proportional valve to a main injector of the at least one fuel injector unit, and wherein dispensing the cleaning substance includes dispensing the cleaning substance upstream of the pilot proportional valve, and upstream of the main proportional valve.

10. The method of claim 1, wherein supplying fuel includes supplying fuel through at least one proportional valve, and wherein dispensing a cleaning substance includes dispensing the cleaning substance downstream of the at least one proportional valve.

11. A system, comprising:
a regeneration assembly configured to regenerate a filter assembly during a regeneration cycle;
a combustion chamber associated with the regeneration assembly;
a fuel injector unit for injecting fuel into the combustion chamber during the regeneration cycle;
a fuel flow path configured to direct fuel to the fuel injector unit; and
an assembly configured for dispensing a cleaning substance into the fuel flow path for cleaning the fuel injector unit during a cleaning cycle.

12. The system of claim 11, wherein the assembly includes a port associated with the fuel flow path, and a service tool providing a supply of cleaning substance and being selectively connectible to the port.

13. The system of claim 11, further including:
at least one proportional valve in the fuel flow path, and wherein the assembly for dispensing a cleaning substance is configured to dispense the cleaning substance into the fuel flow path upstream of the at least one proportional valve.

14. The system of claim 11, further including:
at least one proportional valve in the fuel flow path, and wherein the assembly for dispensing a cleaning substance is configured to dispense the cleaning substance into the fuel flow path downstream of the at least one proportional valve.

15. The system of claim 11, wherein the assembly includes a solenoid activated on/off valve for facilitating dispensing of the cleaning substance into the fuel flow path, and
a pressurized supply container connectible to the solenoid activated on/off valve to provide a supply of cleaning substance.

16. The system of claim 15, further including:
a gas source for selectively supplying gas through a gas flow path to the fuel injector unit; and
a controller configured to activate the gas source to supply gas for a predetermined time span before dispensing the cleaning substance, the controller being configured to activate the solenoid activated on/off valve to introduce a predetermined quantity of the cleaning substance, and the controller being configured to activate the gas source to supply gas for a predetermined time span after dispensing the cleaning substance.

17. The system of claim 15, further including:
a diagnostic device configured to monitor at least one parameter indicative that the fuel injector unit may benefit from introduction of a cleaning substance; and
a controller configured to receive a signal from the diagnostic device and activate the solenoid activated on/off valve to introduce a predetermined quantity of the cleaning substance in response to a signal indicating that the fuel injector unit may benefit from a cleaning cycle.

18. A machine, comprising:
an engine system including an exhaust flow path;
a filter assembly in the exhaust flow path;
a regeneration assembly proximate the exhaust flow path upstream of the filter assembly, the regeneration assembly including a combustion chamber and configured to regenerate the filter assembly during a regeneration cycle;
at least one fuel supply circuit and at least one fuel injector unit associated with the combustion chamber; and
an assembly configured to dispense a cleaning substance into the at least one fuel supply circuit and to the at least one fuel injector unit.

19. The machine of claim 18, wherein the assembly configured to dispense a cleaning substance includes:
a controller configured to activate a solenoid activated on/off valve to dispense the cleaning substance at least one of:
after a predetermined number of regeneration cycles; and
in response to a signal from at least one diagnostic device monitoring at least one parameter associated with fuel injector unit performance.

20. A machine, comprising:
an engine system including an exhaust flow path;
an aftertreatment assembly associated with the exhaust flow path;
an injector unit configured to inject fluid into the exhaust flow path upstream of the aftertreatment assembly; and
an assembly configured to dispense a cleaning substance to the injector unit.

21. The machine of claim 20, wherein the assembly configured to dispense a cleaning substance includes:
a controller configured to activate a valve to dispense the cleaning substance in response to a signal from at least one diagnostic device monitoring at least one parameter associated with injector unit performance.

22. A kit for adapting a fluid flow line to receive a cleaning substance for fuel supply components, comprising:
a device configured to hold a quantity of cleaning substance suitable for cleaning fuel supply components;
a length of supply line configured to be attached to a fluid flow line;
a connection configured to enable the device to be attached to the supply line; and
a check valve configured to be attached to the supply line.

23. The kit of claim 22, wherein the device is a service tool and the connection is a port adapter configured to receive the service tool.

24. The kit of claim 22, wherein the device is a pressurized container and the connection is an adapter configured to receive the pressurized container.

25. The kit of claim 22, further including a valve configured to be attached to the supply line to control the flow of cleaning substance.

26. The kit of claim 25, wherein the valve is chosen from a metering valve and a solenoid activated on/off valve.

27. A method of cleaning a fluid injection nozzle associated with an aftertreatment assembly, comprising:
dispensing a cleaning substance into a fluid flow path during a cleaning cycle; and
directing the cleaning substance through the fluid flow path and through at least one fluid injection nozzle associated with the aftertreatment assembly.

28. The method of claim 27, further comprising:
selectively activating a solenoid activated on/off valve to permit dispensing of the cleaning substance into the fluid flow path;
supplying the cleaning substance from a device chosen from a service tool and a pressurized container; and
preventing backflow toward the device with a check valve.

29. A system for supplying to a fluid flow line a cleaning substance suitable for cleaning fuel supply components, comprising:
a device configured to hold and dispense a quantity of cleaning substance;
a fluid flow line;
a cleaning substance supply line configured to be connected to the fluid flow line;
a connector configured to connect the device to the supply line; and
a check valve connected to the supply line.

30. The system of claim 29, wherein the fluid flow line is one of a fuel flow line and a gas flow line.

31. The system of claim 29, wherein the device is one of a service tool and a pressurized container.

32. The system of claim 29, further including one of an on/off valve and a metering valve associated with the supply line and configured to control the flow of cleaning solution.
